(19) United States
(12) Patent Application Publication
(10) Pub. No.: US 2024/0110803 A1
(43) Pub. Date: Apr. 4, 2024

(54) INFORMATION PROCESSING APPARATUS

(71) Applicant: TOYOTA JIDOSHA KABUSHIKI KAISHA, Toyota-shi (JP)

(72) Inventors: Hiroto TOMIDA, Shibuya-ku (JP); Ryosuke KOBAYASHI, Nagakute-shi (JP); Satoshi KOMAMINE, Nagoya-shi (JP); Tetsuya IDE, Chofu-shi (JP); Mayuko ABE, Shinagawa-ku (JP); Makoto AKAHANE, Yokohama-shi (JP); Haruki OGURI, Toyota-shi (JP)

(73) Assignee: TOYOTA JIDOSHA KABUSHIKI KAISHA, Toyota-shi (JP)

(21) Appl. No.: 18/472,221

(22) Filed: Sep. 22, 2023

(30) Foreign Application Priority Data
Oct. 4, 2022 (JP) 2022-160563

(51) Int. Cl. G01C 21/34; G01C 21/36

(52) U.S. Cl. CPC G01C 21/3461; G01C 21/3617

(57) ABSTRACT

An information processing apparatus includes a controller configured to extract roads that are difficult for a particular truck to travel based on a travel history of one or more trucks and generate route guidance such that roads that are easy for the particular truck to travel are given priority by avoiding at least one road among the extracted roads.

### CROSS-REFERENCE TO RELATED APPLICATION

This application claims priority to Japanese Patent Application No. 2022-160563 filed on Oct. 4, 2022, the entire contents of which are incorporated herein by reference.

### TECHNICAL FIELD

The present disclosure relates to an information processing apparatus.

### BACKGROUND

Technology for vehicle route guidance is known. For example, Patent Literature (PTL) 1 discloses technology for estimating the position on a road where a vehicle and an oncoming vehicle can pass each other.

### CITATION LIST

### Patent Literature

PTL 1: JP 2006-106945 A

### SUMMARY

Conventional car navigation systems have room for improvement in that they sometimes provide guidance along routes that are difficult for trucks to travel.

It would be helpful to improve technology for vehicle route guidance.

An information processing apparatus according to an embodiment of the present disclosure is an information processing apparatus including a controller configured to:
extract roads that are difficult for a particular truck to travel based on a travel history of one or more trucks; and
generate route guidance such that roads that are easy for the particular truck to travel are given priority by avoiding at least one road among the extracted roads.

According to an embodiment of the present disclosure, technology for vehicle route guidance is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a block diagram illustrating a schematic configuration of an information processing apparatus;

FIG. 3 is a block diagram illustrating a schematic configuration of a terminal apparatus; and

FIG. 4 is a flowchart illustrating operations of the information processing apparatus.

### DETAILED DESCRIPTION

Hereinafter, some embodiments of the present disclosure will be described with reference to the drawings. In the drawings, the same or corresponding portions are denoted by the same reference numerals. In the descriptions of the embodiments, detailed descriptions of the same or corresponding portions are omitted or simplified, as appropriate.

### Outline of Embodiment

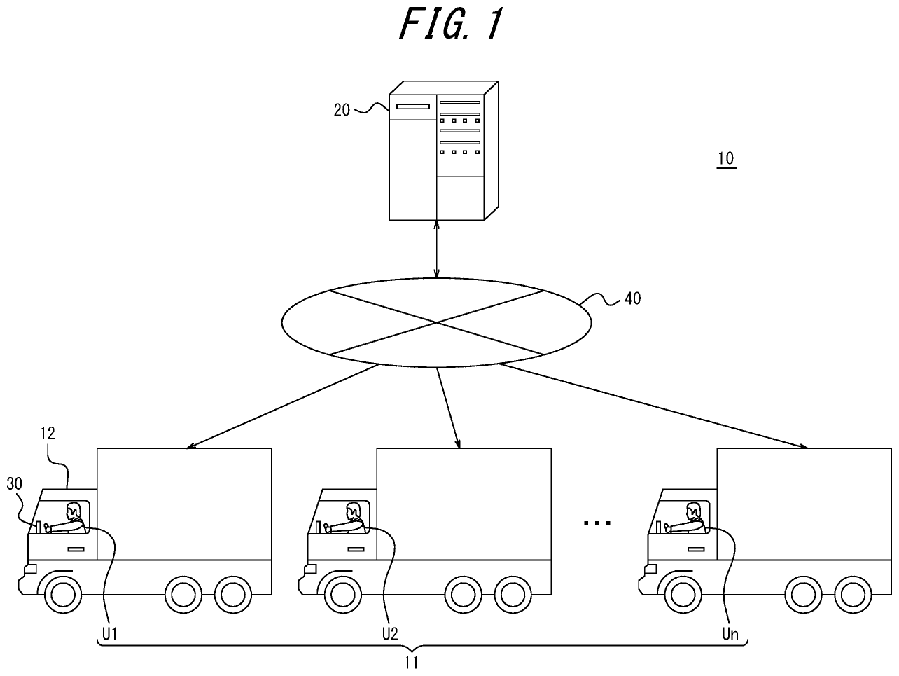

A system 10 according to an embodiment of the present disclosure will be outlined with reference to FIG. 1. The system 10 according to the present embodiment includes an information processing apparatus 20 and a terminal apparatus 30 (mounted on a truck 12). The information processing apparatus 20 can communicate with the terminal apparatus 30 via a network 40 including, for example, the Internet, a mobile communication network, or the like. The information processing apparatus 20 may be able to communicate with one or more other terminal apparatuses via the network 40.

The information processing apparatus 20 is installed in a facility such as a data center. The information processing apparatus 20 is a computer such as a server that belongs to a cloud computing system or another type of computing system.

The terminal apparatus 30 is mounted on the truck 12 ridden by a user U1, i.e., the driver, and is used by the user U1. The terminal apparatus 30 is capable of acquiring the vehicle status or travel data of the truck 12 and is an in-vehicle device, such as a car navigation device. Alternatively, the terminal apparatus 30 may be connected to the truck 12 as an external device or may be held by the user U1. The terminal apparatus 30 may, for example, be a mobile device such as a mobile phone, a smartphone, or a tablet.

In a case in which the information processing apparatus 20 is capable of communicating with one or more other terminal apparatuses, the other terminal apparatuses are mounted on trucks and used by users U2, . . . , Un who drive the trucks. Such terminal apparatuses are, for example, an in-vehicle device such as a car navigation device. Alternatively, such terminal apparatuses may be connected to the trucks as external devices or may be held by the users U2, . . . , Un. Such terminal apparatuses are, for example, mobile devices such as a mobile phone, a smartphone, or a tablet. The number n of users 11 may be any integer equal to or greater than 2.

The truck 12 may be any type of automobile, such as a gasoline-powered vehicle, a diesel-powered vehicle, a hybrid electric vehicle (HEV), a plug-in hybrid electric vehicle (PHEV), a battery electric vehicle (BEV), or a fuel cell electric vehicle (FCEV), though these examples are not limiting. The truck 12, which is driven by a driver in the present embodiment, may be automated at any level. The level of automation is, for example, one of level 1 to level 5 according to the classification of the Society of Automotive Engineers (SAE). The truck 12 may be a Mobility as a Service (MaaS) dedicated vehicle. The number of trucks 12 included in the system 10 may be freely determined.

In the present embodiment, the system 10 is used in a car navigation service for trucks.

First, an outline of the present embodiment will be described, and details thereof will be described later. The information processing apparatus 20 extracts roads that are difficult for a particular truck 12 to travel based on a travel history of one or more trucks. The “one or more trucks” include the particular truck 12. The information processing apparatus 20 generates route guidance such that roads that are easy for the particular truck 12 to travel are given priority by avoiding at least one road among the extracted roads.

According to the present embodiment, roads that are difficult for a particular truck 12 to travel are thus extracted based on a travel history of one or more trucks. In a conventional car navigation system, the travel history of individual trucks is not taken into account, and hence guidance may include roads that are difficult for a particular truck 12 to travel. Such roads can be avoided insofar as possible, however, according to the present embodiment. Technology for vehicle route guidance is therefore improved in that it is easier to direct individual trucks to roads that are easier to travel, contributing to safe travel by trucks.

Next, configurations of the system 10 will be described in detail.

<Information Processing Apparatus Configuration>

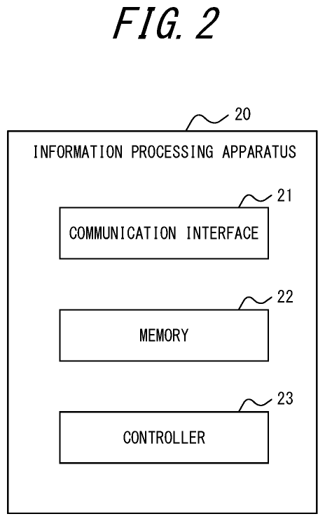

As illustrated in FIG. 2, the information processing apparatus 20 includes a communication interface 21, a memory 22, and a controller 23.

The communication interface 21 includes at least one communication interface for connecting to the network 40. The communication interface may be compliant with, for example, mobile communication standards, wired local area network (LAN) standards, or wireless LAN standards, but these examples are not limiting. The communication interface may be compliant with any appropriate communication standards. In the present embodiment, the information processing apparatus 20 communicates with each of one or more trucks via the communication interface 21 and the network 40.

The memory 22 includes one or more memories. The memories included in the memory 22 may each function as, for example, a main memory, an auxiliary memory, or a cache memory. The memory 22 stores any information used for operations of the information processing apparatus 20. For example, the memory 22 may store a system program, an application program, a database, map information, and the like. The information stored in the memory 22 may be updated with, for example, information acquired from the network 40 via the communication interface 21.

In the present embodiment, a first database and a second database are stored in the memory 22.

The first database stores identification information (such as a vehicle number) and vehicle specifications (such as vehicle dimensions, cargo bed dimensions, wheelbase, gross vehicle weight, and maximum loading capacity) for each of one or more trucks. However, the first database is not limited to these examples and can store any other information indicating the attributes of each truck. For example, the first database may store the manufacturer, body shape (such as flat body, van body, wing body, or dump), or use (such as refrigerated truck, garbage truck, or aerial work platform) of each truck.

The second database stores the identification information and travel history of each of one or more trucks. The “travel history” includes the travel route of the truck, information that changes as the truck travels, and information about the condition of components of the truck, acquired from the terminal apparatus 30 of each truck via the network 40. The “travel route of the truck” indicates the route traveled by the truck on a map indicated by map information. The “information that changes as the truck travels” includes, for example, information indicating the position, acceleration, speed, distance traveled, shift position, accelerator operation status, brake operation status, clutch operation status, or steering wheel operation status of the truck. The “information about the condition of components of the truck” includes, for example, information indicating the condition of electric retractable mirrors or the condition of lights. However, the travel history is not limited to these examples and may include any other information, such as the time of acquisition of each piece of data (time stamp or the like).

In other words, the first database can store static information that does not change as each truck travels, and the second database can store dynamic information acquired as each truck travels.

The controller 23 includes at least one processor, at least one programmable circuit, at least one dedicated circuit, or a combination of these. The controller 23 controls the operations of the entire information processing apparatus 20.

In the present embodiment, the controller 23 stores the vehicle information for each of the one or more trucks, received from the terminal apparatus 30 via the network 40, in a second database in the memory 22.

In the present embodiment, the controller 23 generates route guidance indicating the route from the current location of each of the one or more trucks to a desired destination of the user 11 in response to a route search request (described below) received from the terminal apparatus 30 via the network 40.

<Terminal Apparatus Configuration>

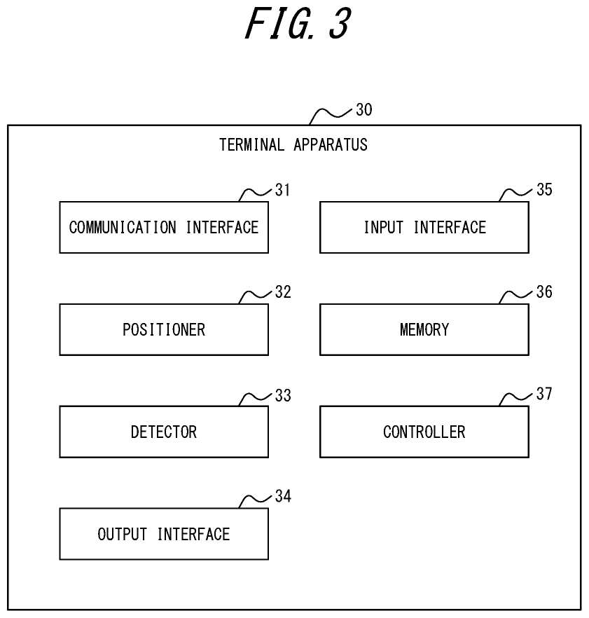

As illustrated in FIG. 3, the terminal apparatus 30 includes a communication interface 31, a positioner 32, a detector 33, an output interface 34, an input interface 35, a memory 36, and a controller 37.

The communication interface 31 includes at least one communication interface for connecting to the network 40. The communication interface is compliant with mobile communication standards such as the 4th generation (4G) standard or the 5th generation (5G) standard, for example, but these examples are not limiting. In the present embodiment, the one or more trucks communicate with the information processing apparatus 20 via the communication interface 31 and the network 40.

The positioner 32 includes one or more apparatuses configured to acquire positional information for each of the one or more trucks. Specifically, the positioner 32 includes a receiver corresponding to the Global Positioning System (GPS), for example, but is not limited to this and may include a receiver corresponding to any satellite positioning system.

The detector 33 includes any sensor module capable of acquiring information about each of the one or more trucks themselves and about the surroundings of each truck. For example, the sensor module may include a distance sensor such as LiDAR (light detection and ranging), an infrared sensor, a camera, a speed sensor, an acceleration sensor, an angular velocity sensor, a geomagnetic sensor, an orientation sensor, or combinations of these.

The output interface 34 may include at least one output device for outputting information to notify the user. The output device is a device such as a display for outputting information as images or video, a speaker for outputting information as audio, or the like, for example, but is not limited to these. The display is, for example, a liquid crystal display (LCD) or an organic electro luminescent (EL) display. The output interface 34 may include an interface for connecting to an external output device.

The input interface 35 includes at least one interface for input that detects user input. The interface for input is, for example, a physical key, a capacitive key, a pointing device, a touch screen integrally provided with the display, or a microphone. The input interface 35 may include an interface for connecting to an external input device. As an interface for connection, for example, an interface compliant with a standard such as Universal Serial Bus (USB) or Bluetooth® (Bluetooth is a registered trademark in Japan, other countries, or both) can be used.

In the present embodiment, the input interface 35 accepts a request by the user 11 of each of one or more trucks to search for a route from the current location of each truck to a desired destination of the user 11 (hereinafter also referred to as a “route search request”). The route search request includes information indicating the current location and destination of each truck but may also include any other information, such as information indicating a transit point or detour point.

The memory 36 includes one or more memories. The memories are semiconductor memories, magnetic memories, optical memories, or the like, for example, but are not limited to these. The memories included in the memory 36 may each function as, for example, a main memory, an auxiliary memory, or a cache memory. The memory 36 stores any information used for operations of each of the one or more trucks. For example, the memory 36 may store a system program, an application program, embedded software, map information, and the like. The map information may include any geospatial information, such as a numerical map (including basic map information, numerical elevation data, and the like) provided by the Geospatial Information Authority of Japan. The information stored in the memory 36 may be updated with, for example, information acquired from the network 40 via the communication interface 31.

In the present embodiment, the memory 36 stores vehicle information acquired via the positioner 32 and the detector 33.

The controller 37 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 37 executes processes related to the operations of the terminal apparatus 30 while controlling the components of the terminal apparatus 30.

In the present embodiment, the controller 37 transmits the vehicle information, acquired via the positioner 32 and the detector 33, in association with the corresponding truck to the communication interface 21 of the information processing apparatus 20 via the communication interface 31 and the network 40. The controller 37 also transmits the route search request, inputted via the input interface 35 by the user 11 of each truck, to the information processing apparatus 20 via the network 40.

<Flow of Operations of Information Processing Apparatus>

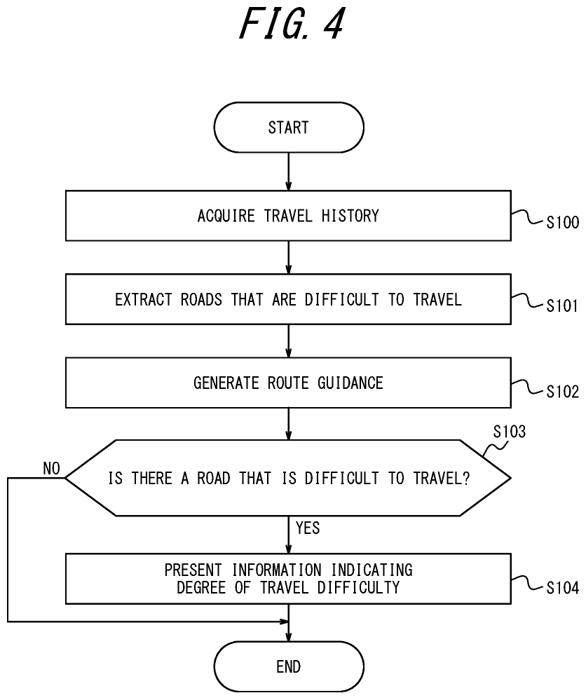

Operations of the information processing apparatus 20 according to the first embodiment will be described with reference to FIG. 4. The operations in FIG. 4 correspond to a method according to the present embodiment. The operations in FIG. 4 can be performed at any time, such as when the information processing apparatus 20 receives the route search request. In the following description, it is assumed that the information processing apparatus 20 receives a route search request, via the network 40 from the terminal apparatus 30 mounted on a particular truck 12, to search for a route from the current location of the particular truck 12 to a destination to which the user U1 is headed for the first time.

Step S100: the controller 23 of the information processing apparatus 20 acquires the travel history of one or more trucks. As described above, the one or more trucks include a particular truck 12.

Specifically, the controller 23 reads the travel history of a particular truck 12 from the memory 22 by searching the second database using, as a query, the identification information for the particular truck 12 ridden by the user U1. Furthermore, the controller 23 searches the first database to extract trucks of the same type as the particular truck 12. “Trucks of the same type as the particular truck 12” refer to trucks that have the same or substantially the same vehicle specifications as the particular truck 12. “Trucks with substantially the same specifications as the particular truck 12” refer to trucks that are offered by the same or a different manufacturer as the truck 12 and whose differences in vehicle specifications (such as vehicle dimensions) from the particular truck 12 fall within a predetermined range (for example, within a few percent). The controller 23 reads the travel history of each of one or more trucks from the memory 22 by searching the second database using, as a query, the identification information for the extracted trucks of the same type as the truck 12. The controller 23 can thus acquire the travel history of one or more trucks by reading the travel history of a particular truck 12 and the travel history of trucks of the same type as the particular truck 12 from the memory 22.

Step S101: the controller 23 extracts roads that are difficult for a particular truck 12 to travel.

Specifically, the controller 23 refers to the travel history acquired in step S100, estimates that roads satisfying a predetermined condition are narrow roads, and extracts the narrow roads as roads that are difficult for the particular truck 12 to drive. While the predetermined condition can be set freely, first through third examples are illustrated below as specific examples. Through steps S100 and S101, the information processing apparatus 20 can extract roads that are difficult for a particular truck to travel based on a travel history of one or more trucks.

As a first example, the predetermined condition can be that the average speed of one or more trucks (i.e., the particular truck 12 and the trucks of the same type as the particular truck 12) is less than a predetermined speed, the number of instances of braking of the one or more trucks exceeds a predetermined number, or both. In this case, the travel history includes information indicating the speed and number of instances of braking of each truck. The controller 23 refers to the travel history to identify roads on which the average speed of the one or more trucks is less than a predetermined speed, the number of instances of braking of the one or more trucks exceeds a predetermined number, or both. The predetermined speed can be freely determined but may, for example, be 50% of the legal speed. The predetermined number of instances of braking may be freely determined but may, for example, be three times per 5 m. In other words, the controller 23 identifies roads on which the speed of the one or more trucks was slow, the number of instances of braking of the one or more trucks was high, or both. The controller 23 can estimate the identified roads as narrow roads and extract the narrow roads as roads that are difficult for the particular truck 12 to travel. For example, in a case in which the average speed of the one or more trucks traveling on a road with a legal speed of 30 km/h is 12 km/h, that road can be extracted as a road that is difficult for the particular truck 12 to travel.

As a second example, the predetermined condition can be that a predetermined time or longer is required for vehicles to pass each other. In this case, the travel history includes the time required for one or more trucks (i.e., the particular truck 12 and trucks of the same type as the particular truck 12) and an oncoming vehicle to pass each other. The controller 23 refers to the travel history to identify roads on which the time required to pass each other is equal to or greater than a predetermined time. In general, when a truck and an oncoming vehicle pass each other, the time required for passing each other tends to increase on narrow roads due to the need to reduce speed or drive slowly from the standpoint of safety, for example to avoid collisions between vehicles. Accordingly, when a road on which the time required to pass each other is equal to or longer than a predetermined time is identified, the controller 23 can estimate that road as a narrow road and extract the narrow road as a road that is difficult for the particular truck 12 to travel. The predetermined time can be freely determined but may, for example, be a time calculated based on statistical data (such as the 85th percentile speed) on the average speed of vehicles traveling on the road in question. Any appropriate method can be employed to calculate the time required to pass each other. For example, the controller 23 may acquire, via the network 40 from the terminal apparatus 30 of each of the one or more trucks, images or video of the surroundings of the truck as acquired via the detector 33 of the terminal apparatus 30. In this case, the detector 33 may be an omnidirectional camera capable of capturing images of the surroundings of each truck. By analyzing the acquired images or video, the controller 23 can calculate the time required for each truck and an oncoming vehicle to pass each other.

As a third example, the predetermined condition can be that one or more trucks (i.e., a particular truck 12 and trucks of the same type as the particular truck 12) traveled with an electric retractable mirror in a retracted state. In this case, the travel history includes information indicating the speed and the state of the electric retractable mirrors of each truck. The controller 23 refers to the travel history to determine whether there are roads on which one or more trucks have traveled with the electric retractable mirrors in a retracted state. Such a road can be considered so narrow that the particular truck 12 cannot travel without retracting the electric retractable mirrors to avoid contact with an oncoming vehicle or an obstacle (such as a concrete block wall). Therefore, in a case in which it is detected that one or more trucks traveled on a road with the electric retractable mirrors in a retracted state, that road can be extracted as a road that it is difficult for a particular truck 12 to travel.

Step S102: the controller 23 generates route guidance such that roads that are easy for the particular truck 12 to travel are given priority by avoiding at least one road among the roads extracted in step S101.

Any appropriate method can be adopted to avoid at least one road. For example, the controller 23 may determine, for each road extracted in step S101, the priority for exclusion from the route guidance. Any method can be employed to determine the priority. For example, the controller 23 may determine the degree of travel difficulty for the particular truck 12 for each road, and based on the results of the determination, determine the priority for exclusion of the road from the route guidance. The degree of travel difficulty may, for example, be indicated by a score that serves as an evaluation criterion. The score may be a number (for example, an integer from 0 to 100) or a grade (for example, a five-step evaluation with degrees of difficulty of 1 to 5). In this case, the higher the score, the more difficult the road is to travel, indicating that it is more difficult for the particular truck 12 to travel. In the first example described above, the score can be calculated to be larger as the average speed is slower, or as the number of instances of braking per unit distance is greater, for the one or more trucks. In the second example, the score can be calculated to be larger as the time required to pass each other is longer. In the third example, the score can be calculated to be larger as the number of trucks that traveled with the electric retractable mirrors in a retracted state is greater. The controller 23 can then avoid at least one road by excluding the roads extracted in step S101, in descending order of the score for the degree of travel difficulty, from the route from the current location of the particular truck 12 to the desired destination of the user U1, as indicated by the route search request. In a case in which there is a plurality of road options for the route to the destination, the roads can be excluded in descending order of the score for the degree of travel difficulty, but in a case in which a road has no alternative options (i.e., is unavoidable), that road is naturally selected for the route regardless of the degree of travel difficulty. This makes it easier for the controller 23 to generate route guidance such that roads that are easy for the particular truck 12 to travel are given priority.

Step S103: the controller 23 determines whether the route guidance generated in step S102 includes one or more roads that are difficult for the particular truck 12 to travel. In a case in which it is determined that the route guidance includes one or more roads that are difficult for the particular truck 12 to travel (step S103: Yes), the process advances to step S104. Conversely, in a case in which it is determined that the route guidance does not include roads that are difficult for the particular truck 12 to travel (step S103: No), the process ends.

In a case in which the destination of the particular truck 12 is a residential area or a warehouse on a plot of land in a rural area, one or more roads included in the route to the destination, typically the road immediately before the destination, is often a narrow community road (such as an alley or agricultural road) or a straight road without detours. In this case, in step S102 above, one or more of the roads extracted in step S101 will be included in the route guidance rather than being excluded. The controller 23 determines in this case that the route guidance includes one or more roads that are difficult for the particular truck 12 to travel.

Step S104: in a case in which the route guidance includes one or more roads that are difficult for the particular truck 12 to travel (step S103: Yes), the controller 23 transmits, via the communication interface 21, information indicating the degree of travel difficulty for the particular truck 12 for each road among the one or more roads to the terminal apparatus 30 used by the user U1 of the particular truck 12 and causes the terminal apparatus 30 to output the information.

The information indicating the degree of travel difficulty for the particular truck 12 can be any information that easily enables the user U1 to understand the degree of travel difficulty for the particular truck 12. For example, the information indicating the degree of travel difficulty may be the score described above in step S102. The controller 23 transmits, via the communication interface 21 and the network 40, the information indicating the degree of travel difficulty in association with each road among the one or more roads to the terminal apparatus 30 used by the user U1 of the particular truck 12 and causes the output interface 34 to output the information. The timing for outputting the information indicating the degree of travel difficulty may be any time before the particular truck 12 enters a corresponding road. For example, the information indicating the degree of travel difficulty may be outputted when it is detected that the particular truck 12 has approached the corresponding road to within a predetermined distance (for example, 800 m).

Conventional car navigation systems do not take into account the travel history of individual trucks and therefore only provide uniform, abstract information such as “be careful of the road width”. In contrast, according to the present embodiment, individual, specific information indicating the degree to which a road to be entered is difficult for the particular truck 12 to travel can be presented to the user U1. By using the terminal apparatus 30, the user U1 can learn the level of difficulty for the particular truck 12 before entering a road that is difficult to travel, such as a narrow community road. This minimizes the occurrence of unexpected situations for the user U1. As a result, the user U1 is more likely to drive calmly even on roads that are difficult for the particular truck 12 to travel, thereby further contributing to safe travel by trucks.

In addition to information indicating the degree of travel difficulty, the controller 23 may output images or video of the surroundings (for example, the view from the driver's seat) of each of the one or more trucks while traveling each road, as acquired via the detector 33 of the terminal apparatus 30 or via an external apparatus (such as a drive recorder). Furthermore, the controller 23 may output images or video capturing the steering operations at the time of driving. The outputted images or video can be selected by any method but may, for example, be images or video selected by the administrator of the information processing apparatus 20 as a representative example (for example, images or video of steering wheel operations by a skilled user). The user U1 can thereby be presented with more specific information indicating the degree of travel difficulty on a road that is difficult for the particular truck 12 to travel. As a result, the user U1 is more likely to drive calmly even on roads that are difficult for the particular truck 12 to travel, thereby further contributing to safe travel by trucks.

As described above, the information processing apparatus 20 according to the present embodiment extracts roads that are difficult for the particular truck 12 to travel based on the travel history of one or more trucks. The information processing apparatus 20 generates route guidance such that roads that are easy for the particular truck 12 to travel are given priority by avoiding at least one road among the extracted roads.

According to such a configuration, roads that are difficult for a particular truck 12 to travel are extracted based on the travel history of one or more trucks. In a conventional car navigation system, the travel history of individual trucks is not taken into account, and hence guidance may include roads that are difficult for a particular truck 12 to travel. Such roads can be avoided insofar as possible, however, according to the present embodiment. Technology for vehicle route guidance is therefore improved in that it is easier to direct individual trucks to roads that are easier to travel, contributing to safe travel by trucks.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the information processing apparatus 20 in the above embodiment are distributed to multiple computers capable of communicating with each other can be implemented. For example, an embodiment in which some or all of the components of the information processing apparatus 20 are provided in a particular truck 12 can also be implemented. For example, the terminal apparatus 30 used by the user U1 of a particular truck 12 may be provided with some or all components of the information processing apparatus 20.

For example, an embodiment in which a general purpose computer functions as the information processing apparatus 20 according to the above embodiment can also be implemented. Specifically, a program in which processes for realizing the functions of the information processing apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. An information processing apparatus comprising a controller configured to:
extract roads that are difficult for a particular truck to travel based on a travel history of one or more trucks; and
generate route guidance such that roads that are easy for the particular truck to travel are given priority by avoiding at least one road among the extracted roads.

2. The information processing apparatus according to claim 1, wherein
the travel history includes information indicating a speed and a number of instances of braking of the one or more trucks, and
the controller is configured to estimate that a road on which an average speed of the particular truck and of a truck of a same type as the particular truck is less than a predetermined speed, a road on which the number of instances of braking of the particular truck and of a truck of the same type as the particular truck exceeds a predetermined number, or both is a narrow road and to extract the narrow road as the road that is difficult for the particular truck to travel.

3. The information processing apparatus according to claim 1, wherein
the travel history includes a time required for the one or more trucks and an oncoming vehicle to pass each other, and
the controller is configured to estimate that a road on which the time required to pass each other is equal to or greater than a predetermined time is a narrow road and to extract the narrow road as the road that is difficult for the particular truck to travel.

4. The information processing apparatus according to claim 1, wherein
the travel history includes information indicating a speed and a state of an electric retractable mirror of the one or more trucks, and
the controller is configured to estimate that a road on which it is detected that the particular truck and a truck of a same type as the particular truck traveled with the electric retractable mirror in a retracted state is a narrow road and to extract the narrow road as the road that is difficult for the particular truck to travel.

5. The information processing apparatus according to claim 1, further comprising a communication interface, wherein
in a case in which the route guidance includes one or more roads that are difficult for a particular truck to travel, the controller is configured to transmit, via the communication interface, information indicating a degree of travel difficulty for the particular truck for each road among the one or more roads to a terminal apparatus used by a user of the particular truck and to cause the terminal apparatus to output the information.
